(19) United States
(12) Patent Application Publication
(10) Pub. No.: US 2025/0210215 A1
(43) Pub. Date: Jun. 26, 2025

(54) DEVICES AND METHODS TO TRAP ARRAYS OF ISOLATED PARTICLES OF MULTIPLE SPECIES

(71) Applicant: Wisconsin Alumni Research Foundation, Madison, WI (US)

(72) Inventors: Mikhail Kats, Madison, WI (US); Chengyu Fang, Madison, WI (US); Mark Saffman, Madison, WI (US); Sanket Sushil Deshpande, Madison, WI (US); Preston Huft, Madison, WI (US)

(21) Appl. No.: 18/394,989

(22) Filed: Dec. 22, 2023

(51) Int. Cl. G21K 1/00

(52) U.S. Cl. CPC G21K 1/006

(57) ABSTRACT

Disclosed are devices and methods for controlling multiple species of particles using projected light, including a mask for the same. The mask comprises a substrate that is substantially transparent at a frequency of the projected light; a multiplicity of reflecting regions formed from a reflective material deposited on the substrate that are substantially opaque at the frequency of the projected light, and a subwavelength-thick layer of background material disposed on the substrate and having a multiplicity of apertures therein. The subwavelength-thick layer of background material has a background transparency between the substrate and the reflective material at the frequency of the projected light and the background transparency is selected to form regions of light intensity maxima configured to trap a first species of particle and regions of light intensity minima configured to trap a second species of particle when the light is projected on the mask. Also disclosed are methods of making the mask.

### STATEMENT REGARDING FEDERALLY SPONSORED RESEARCH

This invention was made with government support under grant number 2016136 awarded by the National Science Foundation and DE-AC02-06CH11357 awarded by the Department of Energy. The government has certain rights in the invention.

### BACKGROUND

The field of the disclosure is related to systems and methods for controlling particles. More particularly, the disclosure relates to devices and methods for trapping multiple species particles using projected light.

The ability to confine and manipulate particles using optical techniques has paved the way for a number of scientific advancements. For instance, defect-free artificial crystals have been created using trapped particles and used to investigate various fundamental principles governing interactions and material properties. Neutral atoms have been particularly attractive because of their well-defined quantum structure and charge neutrality. Charge neutrality isolates atoms from charge-related perturbations, and helps to retain quantum information for longer times. In addition, neutral atoms can be controlled individually, and scaled to large systems.

An atom becomes trapped by the coherent interactions between the electromagnetic fields of applied light and oscillating electric dipole moment induced in the atom. Specifically, the electromagnetic fields induce internal atomic energy shifts that generate effective potentials from which confinement forces arise. To trap the atom, the frequencies of the light are typically shifted, or detuned, with respect to the atomic resonance frequencies. In particular, when the frequency of the light is below an atomic transition frequency, or “red detuned,” the induced atomic dipole moment is in-phase, and the atom becomes attracted to the intensity maxima of the light. The attraction strength is dependent upon the magnitude of detuning. By contrast, when the frequency is “blue detuned,” the induced moment is out of phase, and the atom is repelled from the maxima. In addition, the strength of attraction/repulsion can be modified by controlling the intensity or power of the applied light. Higher-intensity light can provide a stronger trapping force and an intensity distribution with higher spatial contrast can also provide a stronger trapping force.

Optical techniques have also been widely used for trapping arrays of atoms for quantum computing and atomic clock applications. Arrays have been prepared in 1-, 2-, or 3-dimensional configurations or optical lattices. Bright, red detuned, arrays localize atoms at the local intensity maxima, while dark, blue detuned, arrays localize the atoms at local intensity minima. In general, dark arrays require more complicated optical systems, but offer the important advantage that by localizing atoms where the intensity is low, there is less perturbation. This is significant for extending the coherence time of atomic qubits and for minimizing disturbance to atoms in optical clocks.

Optical lattices are commonly formed by the interference of light from different sources. For example, a 1D lattice can be created using a standing wave generated by superposing two counter-propagating laser beams. Higher dimensional optical lattices require additional optical sources. For example, a 3D simple-cubic lattice structure can be produced by overlapping three orthogonal standing waves formed using 3 pairs of counter-propagating optical sources. However, atomic positions in a lattice generated by the interference of counter-propagating beams are very sensitive to optical path-length. Slight drifts can cause differential phase shifts between beams, and significantly affect the atomic positions. Although phase shifts can be, in principle, compensated by using active stabilization, such techniques are commonly applied to single atoms. This is because of the increased system complexity required for performing active stabilization on multiple atoms.

To remove the sensitivity in interferometric approaches, limit the use of expensive active optical devices, and increase the scalability of neutral atom arrays, passive projection systems can be used. A projecting system can project an optical pattern onto a cloud of many particles to control their locations in space. In this method, the beam of light is directed to a first mask containing opaque and transparent regions, a first lens, a second mask containing a transparent aperture but is otherwise opaque, and a second lens, to generate an array of approximately Gaussian beams, each of which can be used to trap a single species of particle. There is value in designing a projection system that can trap two different species of particles. However, dual-species particle arrays typically require two separate lasers with different wavelengths for each species and at least some optics which are not shared between the two wavelengths. This significantly adds experimental complexity and cost which is unfavorable for commercialization. As a result, there is a need for a simple and inexpensive system for the simultaneous trapping of multiple species.

### SUMMARY

The present disclosure overcomes the drawbacks of previous technologies by providing a device and method for controlling particles of multiple species using projected light. As a result, the present methods allow for the control of different particles, such as different neutral atoms, with a single optical source projecting light at a single frequency or narrow band of frequencies.

One aspect of the technology provides for a mask for controlling multiple species of particles using projected light. The mask comprises a substrate that is substantially transparent at a frequency of the projected light; a multiplicity of reflecting regions formed from a reflective material deposited on the substrate that are substantially opaque at the frequency of the projected light, and a subwavelength-thick layer of background material disposed on the substrate and having a multiplicity of apertures therein. The subwavelength-thick layer of background material has a background transparency between the substrate and the reflective material at the frequency of the projected light and the background transparency is selected to form regions of light intensity maxima configured to trap a first species of particle and regions of light intensity minima configured to trap a second species of particle when the light is projected on the mask.

Another aspect of the technology provides for a system for controlling multiple species of particles using projected light. The system comprises a particle system configured to provide a plurality of a first species of particles and a plurality of a second species of particles, an optical source configured to generate a beam of light with a red-shift from a resonance of the first species of particles and a blue-shift from a resonance of the second species of particles, and a beam filter positioned between the particle system and plurality of particles, and comprising a first mask as described herein, a first lens, a second mask, and a second lens. The optical source, beam filter, and particle system are arranged such that the beam of light from the optical source passes through the beam filter and is projected on the plurality of first species of particles and the plurality of second species of particles to form an optical pattern that controls the positions of the plurality of first species of particles and plurality of second species of particles in space.

Another aspect of the technology provides for a method for controlling multiple species of particles using projected light. The method comprises generating a beam of light using an optical source; directing the beam of light to a beam filter comprising a first mask as described herein, a first lens, a second mask, and a second lens; forming an optical pattern using the beam filter; and projecting the optical pattern on a plurality of first species of particles and a plurality of second species of particles to control their locations in space.

Another aspect of the technology provides for a method for preparing a mask for controlling multiple species of particles using projected light. The method comprises preparing a multiplicity of reflecting regions that are substantially opaque at a frequency of the projected light on a substrate that is substantially transparent at the frequency of projected light and preparing a subwavelength thick layer of a background material having a multiplicity of apertures in the background material on the substrate. The subwavelength thick layer of a background material has a background transparency between the substrate and the multiplicity of reflecting regions at the frequency of the projected light on the substrate and the background transparency is selected to form regions of light intensity maxima configured to trap a first species of particle and regions of light intensity minima configured to trap a second species of particle when the light is projected on the mask.

### BRIEF DESCRIPTION OF THE DRAWINGS

FIG. 1 is a schematic diagram of a system, in accordance with aspects of the present disclosure.

FIG. 2A is a schematic diagram of one embodiment of a beam filter, in accordance with aspects of the present disclosure.

FIG. 2B is a schematic diagram of another embodiment of a beam filter, in accordance with aspects of the present disclosure.

FIG. 3 is a cross-sectional view of an exemplary mask o, in accordance with aspects of the present disclosure.

FIG. 4 is an illustration of the light intensity immediately after the mask of FIG. 3, in accordance with aspects of the present disclosure.

FIG. 5A is an illustration of an example beam filter, in accordance with aspects of the present disclosure.

FIG. 5B is an illustration of another example beam filter, in accordance with aspects of the present disclosure.

FIG. 5C is an illustration of an example mask for use in the beam filter shown in FIG. 12.

FIG. 6 is an illustration of is an illustration of yet another example beam filter, in accordance with aspects of the present disclosure.

FIG. 7 is an illustration of the light intensity after 4F filtering with an iris simulated using plane-wave decomposition, in accordance with aspects of the present disclosure.

FIG. 8 is an illustration of trapping profiles for two-species atom trapping using a single-wavelength of light, in accordance with aspects of the present disclosure. Panel (a) illustrates an intensity contour showing one bright and one dark trap. Panel (b) illustrates line profiles of the traps from (a).

FIG. 9 shows an exemplary mask for use in the beam filter, in accordance with aspects of the present disclosure.

FIG. 10 illustrates a transmission spectrum (left) and phase difference spectrum of 7 nm germanium film on anti-reflective (AR) coated substrate.

FIG. 11 illustrates a single-species array generator fabrication flow chart and device images. Panel (a) illustrates a lift-off process including lithography, deposition, and lift-off. Panel (b) shows an image of fabricated single-species array generator with dark traps.

FIG. 12 Illustrates dual-species array generator fabrication flow chart and device images. Panel (a) illustrates exemplary amorphous germanium deposited to implement the necessary background transmittance while minimizing the phase difference with the transparent region. Aligned lithography and wet etching are applied to remove the germanium in the bright-trap regions. The bright traps are located in between dark traps. Panel (b) shows a photograph of the fabricated dual-species array generator. Panel (c) shows an optical microscope image of the dual-species array generator.

FIG. 13 is a flowchart setting forth steps of a process, in accordance with the present disclosure.

### DETAILED DESCRIPTION

Conventional particle trapping technologies generally rely on interference between mutually coherent light beams. These approaches suffer from a number of drawbacks, including sensitivity to beam misalignments, source phase drift and phase noise. By contrast, the inventors have discovered that projected light fields can be used to trap particles. As detailed in U.S. Pat. Nos. 9,355,750 and 10,559,392, which are incorporated herein by reference in their entirety, projected light fields can be used to overcome shortcomings of conventional technologies, and provide a number of advantages. For example, particle traps created using projected light fields are scalable, can provide deeper trap depths, and will not change position or depth in response to a source phase drift or noise. In addition, less energy is required per trapping site, thereby allowing more sites for a given energy.

In recognizing practical considerations, such as ease of implementation and cost, the present disclosure introduces a novel approach for trapping multiple particles using light fields. In particular, the present disclosure provides masks for trapping arrays of different species of particles using a single light source, such as a single laser.

As appreciated from the description below, the present invention can be used to improve a variety of technical fields. For example, an atomic particle array, generated in accordance with the present disclosure, can be part of a hardware configuration for a quantum computer or a quantum computation system. Additionally, atoms trapped using methods herein can also be used as atomic clocks or atomic sensors, as well as in quantum simulation applications. Other improved technical fields may include optomechanics, and small-sphere applications. For example, trapped particles (e.g. microspheres, nanospheres) may be used as probes for measuring physical quantities, or as lasers sources for optical frequency combs.

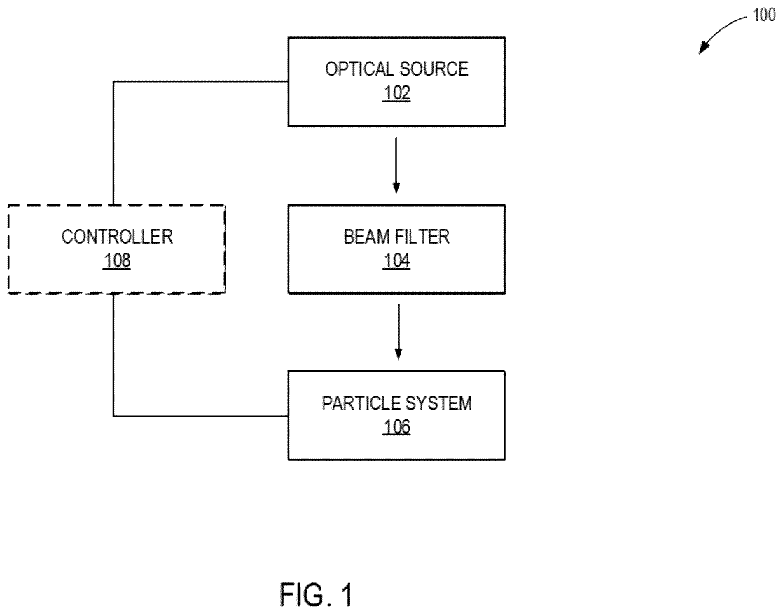

Turning now to FIG. 1, a schematic of an example system 100, in accordance with aspects of the present disclosure, is shown. In general, the system 100 may include an optical source 102, a beam filter 104, and a particle system 106. The system 100 may optionally include a controller 108 in communication with, and configured to control, the optical source 102, the light filter 104, and/or the particle system 106.

The optical source 102 may include various hardware for generating light. In particular, the optical source 102 may be configured to generate light with various frequencies, wavelengths, power levels, spatial profiles, temporal modulations (e.g. periodic or aperiodic), and so on. In some aspects, the optical source 102 may be configured to generate light fields using frequencies shifted from at least one resonance, such as an atomic resonance. For example, the optical source 102 may be configured to generate blue-detuned or red-detuned light, where the amount of detuning may depend upon the species of particles (e.g. atomic species) to be trapped. As an example, the detuning may be in a range between approximately 10 and approximately 100 nanometers.

Where different species of particles are present, the optical source 102 may be configured to generate light fields shifted in from resonance with each of the two different species. For example, the optical source 102 may be configured to generate blue-detuned light with respect to a first species of particle and red-detuned light for the second species of particle, where the amount of detuning may depend upon the species of particles (e.g. atomic species) to be trapped. Suitably, the optical source 102 is selected to have a frequency between a transition frequency of a first species of particle and a transition frequency of a second species of particle. This configuration can produce red-detuned dipole traps for one species of particle and blue-detuned traps for the other species of particle.

In one embodiment, the optical source 102 includes a laser that produces light with wavelengths in a range between approximately 500 nm and approximately 1500 nm, although other wavelengths are possible. In another embodiment, the optical source 102 includes multiple lasers operated at multiple frequencies, where the frequency separation between the lasers is configured to achieve a target coherence. The frequencies may be selected to achieve a full coherence, a partial coherence, or an incoherence between various light regions of an optical pattern. In one non-limiting example, two frequencies can be utilized, where the difference in wavelength can vary up to approximately 100 nanometers, although other values are possible. In this manner, different components forming particular light fields can be configured to be mutually incoherent.

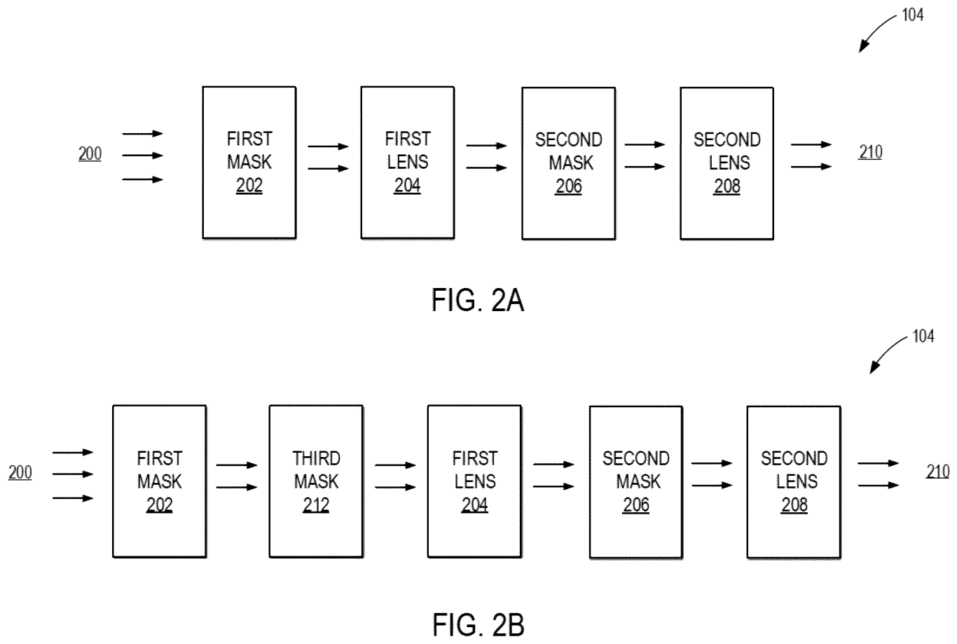

The beam filter 104, positioned downstream from the optical source 102, is configured to control the beam(s) of light generated by the optical source 102. In particular, the beam filter 104 is configured to form an optical pattern using the generated light, which when projected upon various particles (e.g. neutral atoms), will trap the particles in space. Referring to FIG. 2A, the beam filter 104 may include a first mask 202, a first lens 204, a second mask 206 and a second lens 208, configured such that incident light 200 passes sequentially through the first mask 202, the first lens 204, the second mask 206, and second lens 208, thereafter exiting the beam filter 104 to form an optical pattern 210.

In another variation, as shown in FIG. 2B, the beam filter 104 may further include a third mask 212 positioned between the first mask 202 and the first lens 202, where the third mask 212 may include a phase scrambling mask. The phase scrambling mask may include a number of scrambling regions, each transmitting and imparting a phase shift to light passing therethrough. In some embodiments, phase shifts provided by different phase scrambling regions are different, and distributed randomly across the phase scrambling mask over 2π. To this end, the different phase scrambling regions may include different dielectric properties or layers.

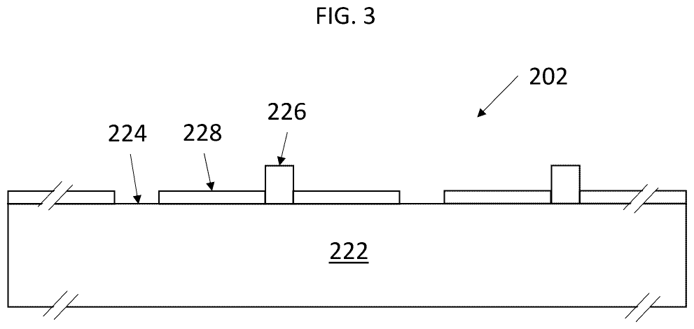

Referring to an exemplary cross-sectional view of the first mask 202 in FIG. 3, the first mask comprises a transparent substrate 222. The transparent substrate may be any material that is substantially transparent at the desired frequency of projected light. “Substantially transparent” means that the ratio of the magnitude of the output electric field divided by the magnitude of the input electric field is greater than 0.90, 0.91, 0.92, 093, 0.94, 0.95, 0.96, 0.97, 0.98, 0.99, or greater than 0.99 and less than or equal to 1.00. An exemplary transparent substrate is fused silica, but other transparent substrates may also be used. Additional examples of transparent substrates include without limitation BK7 glass, soda lime glass, or sapphire.

The first mask 202 also comprises a multiplicity of reflecting regions formed from a reflective material 226 deposited on the substrate. The reflecting material may be any material that is substantially opaque at the desired frequency of projected light. Reflecting material may include materials that absorb the desired frequency of projected light. “Substantially opaque” means that the ratio of the magnitude of the output electric field divided by the magnitude of the input electric field is less than 0.10, 0.09, 0.08, 0.07, 0.06, 0.05, 0.04, 0.03, 0.02, or 0.01 and greater than or equal to 0.00. The opacity of the reflective material may be controlled by controlling the thickness of the reflecting material. The thickness or composition of the reflective material is not a crucial consideration so long as the reflective material is thick enough to be substantially opaque. An exemplary reflective material is a metal, such as gold, but other reflective materials may also be used. Additional examples of reflecting materials include without limitation gold-germanium, copper, chromium, nickel, silver, titanium, zirconium, aluminum, cobalt, molybdenum, tungsten, titanium nitride, or tantalum.

The first mask 202 also comprises a subwavelength-thick layer of background material 228 deposited on the substrate having a multiplicity of apertures 224 therein. The background material 228 has a background transparency between the substrate 222 and the reflective material 226 at the frequency of the projected light. The background transparency is selected to form regions of light intensity maxima configured to trap a first species of particle and regions of light intensity minima configured to trap a second species of particle when the light is projected on the mask. The background transparency may be selected to have substantially equal trapping depths in the regions of light intensity maxima for the first species of particle and regions of light intensity minima for the second species of particle. The ratio of the squared magnitude of the output electric field divided by the squared magnitude of the input electric field of the background material may be between 0.30 and 0.85, 0.50 and 0.85, 0.60 and 0.80, or 0.65 and 0.75.

The transparency of the background material 228 may be controlled by selection of the background and/or the thickness of the background material. Suitably, the background material may less than 20 nm thick. For example, the background material may be less than 19 nm, 18 nm, 17 nm, 16 nm, 15 nm, 14 nm, 13 nm, 12 nm, 11 nm, or 10 nm and at least 2 nm, 3 nm, 4 nm, 5 nm, 6 nm, or 7 nm. The background material may be selected from a direct-gap semiconductor and/or amorphous semiconductor having a band gap less than the photon energy of the frequency of the projected light, e.g., between 500 nm and 1500 nm. Exemplary background materials include amorphous germanium, but other materials may also be used. Additional examples of background materials include without limitation gallium arsenide, amorphous silicon, polycrystalline silicon, indium tin oxide, fluorine-doped tin oxide, indium gallium arsenide. The background material may be selected based on the frequency of projected light to be used. For example, amorphous silicon and polycrystalline silicon may be desirable background materials when the frequency of projected light is less than 800 nm; amorphous germanium and gallium arsenide may be desirable background materials when the frequency of projected light is around 800 nm; and indium tin oxide, fluorine-doped tin oxide, and indium gallium arsenide may be desirable background materials when the frequency of projected light is greater than 800 nm.

The background material 228 may be selected to have a small phase shift between the substrate 222 and the background material at the frequency of the projected light. Suitably, the phase shift may be less than 30°, 28°, 26°, 24°, 22°, 20°, 18°, 16°, 14°, 12°, or 10° between the substrate and the background material.

The area of the apertures and reflecting regions may be selected based on the properties of the materials forming the first mask 202, the species of particles to be controlled, the frequency of projected light, or the components of the system (e.g., the parameters of the second mask 206). Because both the bright and dark traps share one Fourier-plane filter, i.e., second mask 206), an ideal relationship between the area between the apertures and reflecting regions can be determined. For example, where the apertures and the reflecting regions are circular and the ratio of the radius of the apertures to the radius of the reflecting regions may be between 1.0 and 2.0. As demonstrated in the Examples, the ratio between the ratio of the radius of the apertures to the radius of the reflecting regions is about 1.6.

The apertures and reflecting regions may be periodically arranged, but they need not be. The period between the apertures or reflecting regions may be determined to position the particles a certain distance from one another. Suitably, the traps may comprise a waist on the order of microns, e.g., about 1-2 μm. This may result in a periodicity of the at least 4 times the radius of circular apertures or circular reflecting regions.

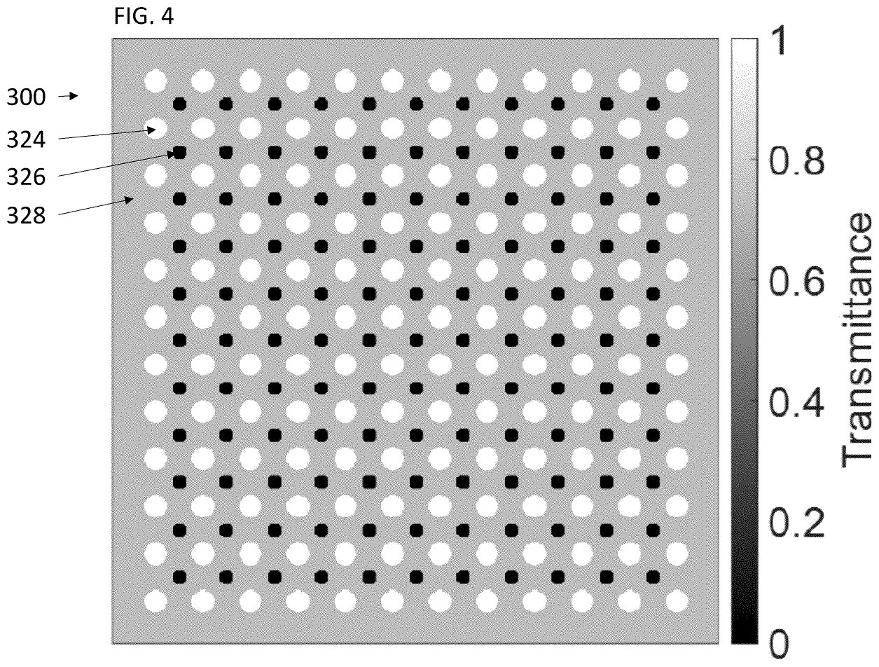

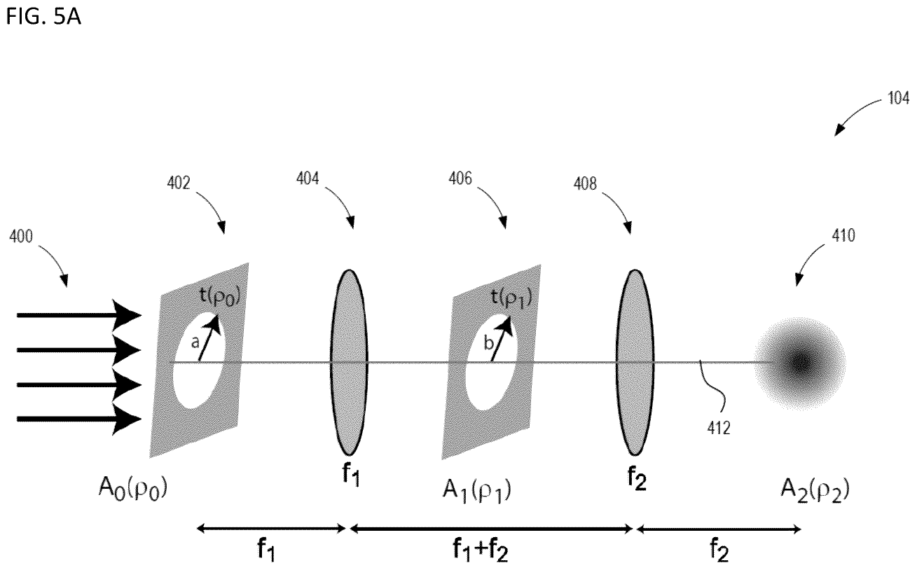

The first mask 202 has a variety of transmitting regions (e.g. apertures) 214 and reflecting regions 216 configured to generate an optical pattern that includes bright and dark regions. FIG. 4 illustrates the light intensity 300 immediately after the mask of FIG. 3. The bright 324 and dark regions 326 are configured to confine the positions of one or more particles in a desired pattern due to optically-induced trapping forces. As used herein, “bright” refers to regions of light intensity maxima, while “dark” refers to regions of light intensity minima.

Referring to FIGS. 3 and 4 again, the first mask 202 also comprises a background material 228 of intermediate transmittance t_{b} (i.e., between 0 and 1) 328 between the bright and dark regions. A first mask 202 comprising bright and dark regions as well as the background region will generate both dark traps and bright traps. The sizes of the single traps at the image plane can be controlled by the focal-length ratio between the first lens and the second lens. Thus, the bright and dark disk sizes on the mask can be many times larger than the trap sizes, which makes fabrication processes much more convenient. Where the optical source has a frequency that is lower than a resonance frequency for a first species of particle, the first species of particle may be trapped in high-intensity regions. Where the same optical source has a frequency that is higher than a resonance frequency for a second species of particle, the second species of particle may be trapped in low-intensity regions. This method can be scaled to larger particles arrays by adding more disks in the array mask and increasing the laser power. The positions and spacing of the different species of particles can be controlled by changing the positions and spacing of the bright and/or dark regions of the first mask 202.

In some non-limiting examples, the first mask 202 includes an arrangement of one or more bright regions and dark regions. For instance, the optical pattern may include an array of bright and dark regions arranged in a one-dimensional (1D) or a two-dimensional (2D) array. Rectilinear grids or other 1D and 2D arrangements may also be possible. For example, non-rectilinear grids, such as parallelogram, triangular, or hexagonal grids, and as well as configurations of bright and dark regions may be produced. In addition, in some embodiments, the optical pattern may include a 3D configuration that includes multiple 1D or 2D arrays of bright and/or dark regions having various desirable spatial separations between them.

Although the aperture and reflecting region may be exemplified as circular, they may have various other shapes (e.g. linear, rectangular, square, oval, and other regular or irregular shapes), numbers, dimensions, and spatial arrangements/separations, depending on the optical pattern desired.

Referring again to FIG. 1, the particle system 106 may be configured to provide and control a number of particles. Specifically, the particle system 106 may include various materials, gases and hardware configured to generate, transfer, manipulate and generally confine the particles. For example, the particle system 106 can include a vacuum system, and capabilities for generating, transferring and confining particles in the vacuum system. In some non-limiting examples, the particles may include any species of neutral atoms, such as Rb, Cs, Ho, Sr, Tb, Ca, and so on, or combinations thereof. However, systems and methods of the present invention are not limited to alkalis or atomic particles, and can be applied to any particles or molecules suitable for optical confinement. In some aspects, the particle system 106 can be configured with capabilities for cooling the particles to any desired temperatures, in order to facilitate trapping. For instance, the particle system 106 may include a laser for cooling the particles to temperatures in a range between 1 and 100 microKelvins, although other values are also possible. Alternatively, the optical source 102 may be used for this purpose. Additionally, the particle system 106 may also include various optical elements to facilitate projection of generated light fields onto the particles therein.

In some embodiments, the system 100 may also include a variety of other hardware and optical elements for directing, transmitting, modifying, focusing, dividing, modulating, and amplifying generated light fields to achieve various shapes, sizes, profiles, orientations, polarizations, and intensities, as well as any other desirable light properties. For instance, in one non-limiting example, the system 100 may include top-hat beam shaper configured to transform a Gaussian-shaped beam emitted by a laser, for example, into a uniform-intensity beam of light with sharp edges. The system 100 may also include other optical elements, such as various beam splitters, beam shapers, shapers, diffractive elements, refractive elements, gratings, mirrors, polarizers, modulators and so forth. These optical elements may be positioned between the optical source 102 and beam filter 104, and/or after the beam filter 104.

In addition, the system 100 can optionally include other capabilities, including hardware controlling or interrogating quantum states of particles configured and arranged in accordance with the present disclosure. Such capabilities facilitate applications including quantum computation, and so forth. These, along with other tasks, may optionally be performed by the controller 108 shown in FIG. 1. For instance, the controller 108 may be configured to trigger the optical source 102 to generate light. Additionally, or alternatively, the controller 108 may also be configured to control operation of the particle system 106, and its various components there.

In some embodiments, the beam filter 104 of the system 100 may be configured to generate an optical pattern using a Fourier filtering or “4f” optical arrangement. FIG. SA provides an illustrate example where the beam filter 104 includes a first mask 402 having a circular aperture with radius a, a first lens 404 with focal length f₁, a second mask 406 having a circular aperture with radius b, and a second lens 408 with focal length f₂. As shown, the first mask 402 and the second mask 406 are positioned at the focal length f₁ of the first lens 404. In addition, the second mask 406 is positioned at the focal length f₂ of the second lens. 408. When the beam filter 104 is uniformly illuminated, a portion of the input light 400 traverses through the first aperture 402, located at the input plane, and the first lens 404 produces an Airy light pattern at its back focal plane where the second mask 406 is positioned. The second mask 406 then filters the Airy light pattern, and the filtered Airy pattern is Fourier transformed by the second lens 408 to produce the optical pattern 410 at the output plane. Using standard optical diffraction theory the field at the output plane is given by:

$${A}_{2} ( {ρ}_{2} ) = - {A}_{0} \frac{α k}{{f}_{2}} {\int }_{0}^{b} d {ρ}_{1} {J}_{0} ( \frac{{ρ}_{2} k}{{f}_{2}} {ρ}_{1} ) {J}_{1} ( \frac{α k}{{f}_{1}} {ρ}_{1} ) ; \qquad ( 1 )$$

where A₀ is the amplitude of the input light 400. The finite integral of Bessel functions in Eqn. 1 can be expressed as a power series in b using

$${\int }_{0}^{b} dz {J}_{0} ( cz ) {J}_{1} ( dz ) = {\sum }_{j = 0}^{∞} \frac{{( - 1 )}^{j}}{j ! ( j + 1 ) ! {( 2 j + 2 )}^{2}} {F}_{1} ( - j , - 1 - j ; 1 ; {c}^{2} / {d}^{2} ) {{b}^{2 + 2 j} ( d / 2 )}^{1 + 2 j} . \qquad ( 2 )$$

Here, ₂F₁ is the hypergeometric function. In some aspects, the focal lengths and aperture of the second mask 406 may be selected as f₁=f₂=f, and b=(f/ak)x₁, where x₁ is 3.8317 is the first zero of J₁. This selection corresponds to blocking the Airy rings outside of the central lobe, resulting in only a small power loss since the integrated power in the central lobe is 0.84 of the total power I₀πa², with I₀ being the input intensity. With these selections, the output field can be expressed as a power series in ρ₂/a. The leading terms are

$$\frac{{I}_{2} ( {ρ}_{2} )}{{I}_{0}} = 1.978 - 4.147 {( \frac{{ρ}_{2}}{α} )}^{2} + 3.918 {( \frac{{ρ}_{2}}{α} )}^{4} - … . \qquad ( 3 )$$

The resulting optical pattern is referred to as an Airy-Gauss (AG) beam because the beam filter 104 filters an Airy light pattern and the intensity has a near Gaussian form. The AG beam is a quadratic function of ρ₂ near the origin. Matching the quadratic term with that of a Gaussian intensity profile gives

$${I}_{G} = {e}^{- 2 {ρ}_{2}^{2} / {w}_{2}} ,$$

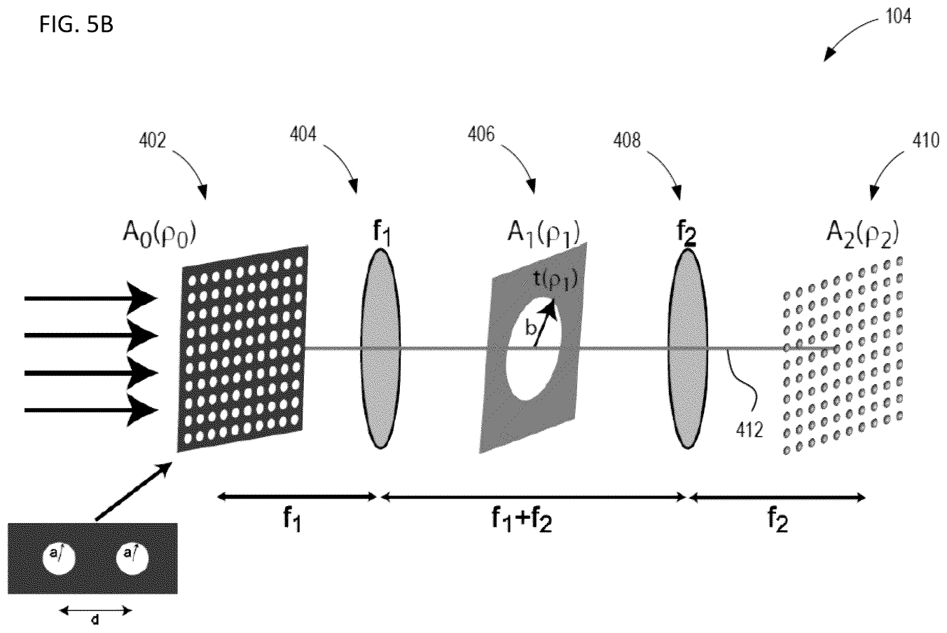

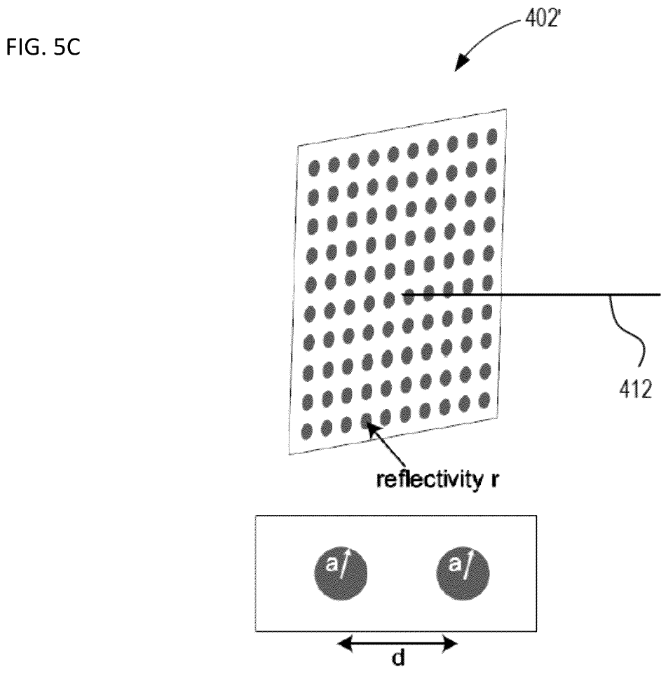

w=0.974a. Thus, to a good approximation, Fourier filtering of a uniformly illuminated circular aperture produces a Gaussian profile with waist parameter slightly less than the aperture radius a. The lobes are sufficiently weak that the profile remains close to that of a Gaussian after diffractive propagation. To note, time reversal symmetry implies that by propagating a Gaussian or near-Gaussian beam through a similar double aperture setup it is possible to efficiently prepare a uniform or near-uniform beam. Therefore, in some implementations, the beam filter 104 shown in FIG. 5A may also be used to prepare a uniform beam. To do so, a Gaussian or near-Gaussian beam may be propagated in reverse through the beam filter 104 (i.e. sequentially through the second lens 408, the second mask 406, the first lens 404 and first mask 402), and thereby transforming the incident beam into a beam with a uniform intensity profile and sharp edges (e.g. a top-hat beam).

The above-described Fourier filtering approach to beam shaping can be readily extended to create an array of Gaussian like beams. Referring to FIG. 5B, in some embodiments, the first mask 402 of the beam filter 104 may include an array of apertures arranged on a two-dimensional grid with spacing d. The light field transmitted through each aperture of the first mask 402 have the form given by Eqn. 1, and appear at position −ρᵢⱼ in the output plane, where ρᵢⱼ is the position of the ij^{th} aperture relative to axis 412 of the first mask 402. Provided that the spacing satisfies the relation d [symbol] 3a, the interference between adjacent beams can be negligible. In some aspects, the array of bright spots at the output plane can be reimaged with any desired magnification to create an array of beams with spacing given by dₒᵤₜ=(df₂/f₁)×M, where M the magnification of the reimaging optics.

The efficiency of the array creation can be defined as ε=Iₜ/I_{d} where Iₜ is the peak intensity of an output beam and I_{d}=P/d² is the input intensity with power P per d×d unit cell. The peak intensity may then be written as:

$${I}_{t} = . 84 \frac{P \frac{π {α}^{2}}{{d}^{2}}}{π {α}^{2}} \times 1.978 = 1.66 {I}_{d} ; \qquad ( 4 )$$

so ε=1.66, independent of the value of a.

An array of dark spots having Gaussian profiles may be desired for trapping particles at local minima of the optical intensity. As such, dark spots can be created by combining a broad input beam, or plane wave, and bright Gaussian beams having equal amplitudes and π phase difference to create a field zero from destructive interference. FIG. 5C provides an illustrative example where the first mask 402′ has an array of reflecting spots with radius a, and which is otherwise fully transmitting, as shown in FIG. 5C. In some embodiments, the modified first mask 402′ may be formed using a transparent substrate, and an array of partially or fully reflecting regions (e.g. circular spots).

Particularly with reference to FIG. 5C, the light field transmitted through the modified first mask 402′ may be written as:

$$E = {E}_{d} - r {\sum }_{ij} {E}_{ij} ; \qquad ( 5 )$$

where E_{d} is the amplitude of the plane wave incident on the modified first mask 402′, Eᵢⱼ is the light field transmitted by ij^{th} aperture, and r is the reflectivity of each spot. The plane wave, which may be much broader than the field of a single aperture, will be fully transmitted through the modified first mask 402′, and beam filter 104. Therefore the field at the output plane will be:

$${E}_{2} = - {E}_{d} - r {\sum }_{ij} {E}_{2 , ij} ; \qquad ( 6 )$$

where E_{2,ij} is the field of Eq. (1) centered at position −ρᵢⱼ in the output plane. Choosing r=1/1.66=0.78 there will be a zero in the field at −ρᵢⱼ surrounded by an intensity pattern with a Gaussian profile. The efficiency may then be given by:

$$ε = \frac{{I}_{t}}{{I}_{d}} = \frac{{I}_{d}}{{I}_{d}} = 1. \qquad ( 7 ) .$$

This efficiency is somewhat lower than the one obtained for an array of bright spots, as described above. Nevertheless, both efficiencies compare favorably with conventional methods. Specifically, darks spots created previously with a Gaussian beam array using diffractive optical elements have ε≤0.51, and a line array has ε≤0.97. By contrast, the present Fourier filtering approach provides substantially better efficiency than a line array since the diffractive multi-spot gratings used to prepare such arrays have efficiencies ˜0.75. In part, this is because beam shapers providing uniform illumination (e.g. top hat beam shaper) can have near 100% efficiency.

In particle or atom trapping, important parameters are the depth of the trap, which is proportional to Iₜ, and the spatial localization. When the trapped particles have motional energy that is small compared to the depth of the trapping potential, the degree of localization is governed by the quadratic variation of the intensity near the trap center. For a bright trap, which localizes a particle near the intensity maxima, the trapping potential can be written as

$$U = {U}_{0} ( 1 - {α}_{⊥} {ρ}^{2} - {α}_{\vert \vert} {z}^{2} + … ) . \qquad ( 8 ) .$$

Here ρ is the radial coordinate and z is the axial coordinate along the trap axis. For a particle with motional temperature T, the virial theorem gives:

$$\begin{matrix}2 {U}_{0} {α}_{⊥} 〈 {ρ}^{2} 〉 = 2 {k}_{B} T \\ 2 {U}_{0} {α}_{\vert \vert} 〈 {z}^{2} 〉 = {k}_{B} T\end{matrix} ; \qquad ( 9 )$$

where k_{B} is the Boltzmann constant. The standard deviations of the particle position are therefore,

$${σ}_{ρ} \sqrt{〈 {ρ}^{2} 〉} = \frac{1}{{α}_{⊥}^{1 / 2}} {( \frac{{k}_{B} T}{{U}_{0}} )}^{1 / 2} , \qquad ( 10 ) .$$

$${σ}_{z} = \sqrt{〈 {z}^{2} 〉} = \frac{1}{{( 2 {α}_{\vert \vert} )}^{1 / 2}} {( \frac{{k}_{B} T}{{U}_{0}} )}^{1 / 2} .$$

For an ideal Gaussian beam with waist parameter w_{G}, and optical wavelength λ, one can have

$${α}_{⊥} = 2 / {ω}_{G}^{2} \qquad ( 11 )$$

$${α}_{11} = \frac{{λ}^{2}}{{π}^{2} {ω}_{G}^{4}} .$$

Equation 10 may then be written as

$$\frac{{σ}_{ρ}}{{( \frac{{k}_{B} T}{{U}_{0}} )}^{1 / 2}} ≡ {\tilde{σ}}_{ρ} = \frac{{ω}_{G}}{\sqrt{2}} , \qquad ( 12 ) .$$

$$\frac{{σ}_{z}}{{( \frac{{k}_{B} T}{{U}_{0}} )}^{1 / 2}} ≡ {\tilde{σ}}_{z} = \frac{{πω}_{G}^{2}}{\sqrt{2} λ} .$$

For Airy-Gauss beam, w_{G}=0.974a, giving position deviations

$${\tilde{σ}}_{ρ} = 0.69 α , \qquad ( 13 ) .$$

$${\tilde{σ}}_{z} = 2.1 \frac{{α}^{2}}{λ} .$$

Using a=d/3, the position factors can be written as

$${\tilde{σ}}_{ρ} = 0.23 d , \qquad ( 14 ) .$$

$${\tilde{σ}}_{z} = 0.233 \frac{{d}^{2}}{λ} .$$

Equations 12 and 14 give the position spreads for bright optical traps. For a dark optical trap created by interfering a Gaussian beam with a plane wave, the axial profile far from the origin is different than that of a bright trap due to the variation of the field phase with z, given by

$$ϕ ( z ) = {tan}^{- 1} [ z / ( π {ω}_{G}^{2} / λ ) ] . \qquad ( 15 ) .$$

Note that the axial profiles are somewhat different for Airy-Gauss and Gaussian beams. Nevertheless the leading quadratic terms are unchanged so the localization parameters are still given by Eqs. 12 and 14. These results can be compared with prior approaches for the Gaussian line array. There the optimum localization is obtained for \tilde{σ}_{ρ}=0.42d and \tilde{σ}_{z}=0.30d²/λ. By contrast, the present approach has a 45% better transverse localization and 22% better axial localization. The localization obtained is \tilde{σ}_{ρ}=0.69 μm and \tilde{σ}_{z}=2.6 μm. Parameters used for numerical calculations included a=b=1.0 μm, λ=0.825 μm, f=2 μm and w_{G}=0.974a. With a temperature to trap depth ratio of less than a factor of 9, which is standard for atoms in optical traps, this implies sub-micron localization in all dimensions.

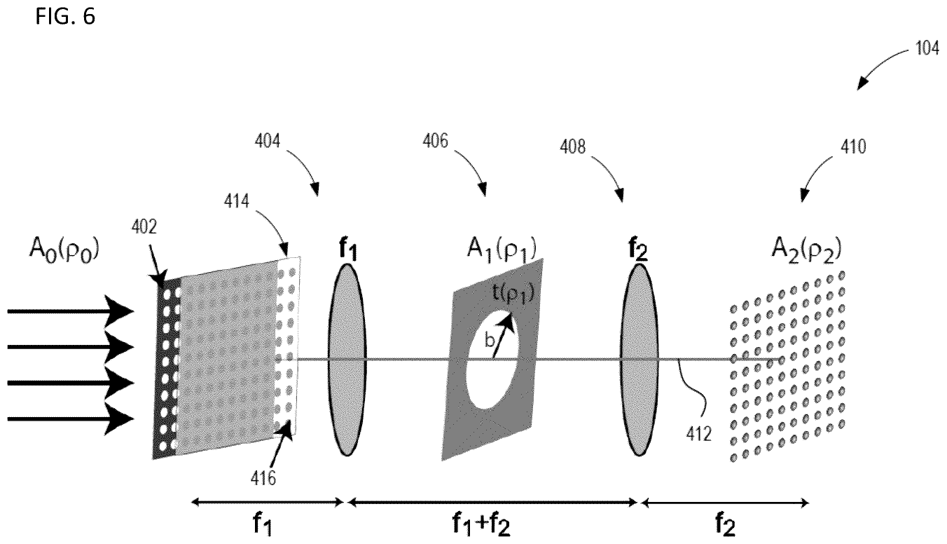

The Fourier filtering approach described herein may lead to formation of multiple trapping planes due to the Talbot effect. Should such planes be undesired, a variation to the configuration of FIG. 5B may be utilized, as shown in FIG. 6. Specifically, a phase scrambling mask 414 may be positioned between the first mask 402 and first lens 404. As shown, the phase scrambling mask 414 may include an array of scrambling regions 416 positioned at ρᵢⱼ, each providing full transmission of light passing therethrough, along with a phase shift φᵢⱼ. In some aspects, the phase shift φᵢⱼ for each scrambling region 416 may vary between 0 and 2π, and be randomly distributed across the phase scrambling mask 414.

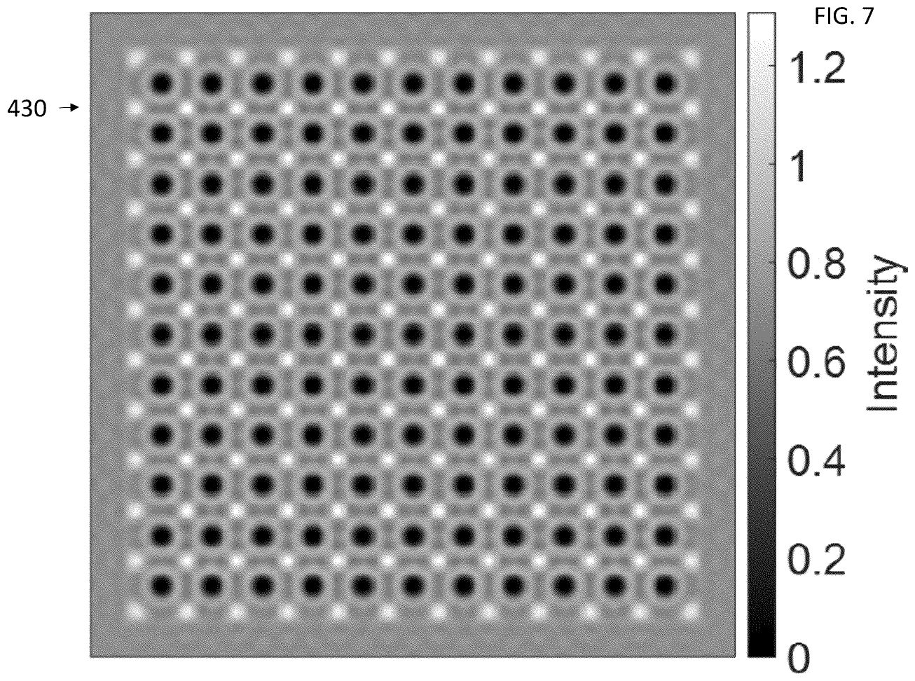

Referring to FIG. 3, the first mask 202 combines both apertures 224 and reflecting regions 226 with intermediate transmittance t_{b} (i.e., between 0 and 1) in a background region 228. The mask 202 with a 4F filtering system will generate both dark traps and bright traps adjacently, as shown in FIG. 7. The sizes of the single traps at the image plane can be controlled by the focal-length ratio between the first lens and the second lens. Thus, the bright and dark disk sizes on the mask can be many times larger than the trap sizes, which makes fabrication processes much more convenient. By way of example, since the laser frequency is lower than Rb resonance frequency, Rb atoms may be trapped in high-intensity regions. At the same time, Cs atoms may be trapped in the low-intensity regions. This method can be scaled to larger atom arrays by adding more disks in the array mask and increasing the laser power. The positions and spacing of the atoms can be controlled by changing the positions and spacing of the disks and apertures on the mask.

An aspect of the technology provides for design considerations for preparing masks for trapping multiple species of particles. The masks for trapping particles, such as neutral atoms, should provide for bright traps having maximum intensity at the trap sites for a given input power, dark traps having zero intensity at the trap sites, the trapping depth should be equal for the bright and dark traps for the two species, or any combination thereof.

One may denote the aperture and background transmission amplitudes as ta and t_{b}, respectively. Here, the transmission amplitude tis a real number between 0 and 1 and is the ratio of the magnitude of the output electric field divided by the magnitude of the input electric field. The field after the first lens, filtering in the Fourier plane, and a second lens transformation, results in an approximate plane wave with amplitude −t_{b}A₀. The field amplitude at the center of the trap may be calculated using Equation 16 below. Here, a is the radius of aperture on the first mask, b is the radius of the aperture of the second mask (i.e., the iris) to filter out the high-frequency components, k is the wavevector of the trapping light, and f is the focal length of two lenses, assuming these two lenses share the same focal length.

$${A}_{2} ( 0 ) = {A}_{0} [ - {t}_{b} - ( {t}_{a} - {t}_{b} ) [ 1 - {J}_{0} ( \frac{kab}{f} ) ] \qquad ( 16 )$$

Practically, two different focal lengths may be used to reduce the size of the trap beams. A quantity referred to as an “efficiency” E may be defined as the ratio between the field amplitude at the trap center and the incident-light amplitude:

$$ε = \frac{{A}_{2} ( 0 )}{{A}_{0}} = - {t}_{b} - ( {t}_{a} - {t}_{b} ) [ 1 - {J}_{0} ( \frac{kab}{f} ) ] \qquad ( 17 )$$

In the case of bright traps, the transmittance of the apertures should ideally be 1. Then, to get the maximum efficiency ε

$$\frac{\partial ε}{\partial b} = 0 \frac{\partial {J}_{0} ( \frac{kab}{f} )}{\partial b} = 0 {J}_{1} ( \frac{kab}{f} ) = 0. \qquad ( 18 )$$

The relationship between Fourier-plane aperture radius b and the bright-trap mask aperture radius α_{bright} may be determined:

$$b = \frac{f}{{ka}_{bright}} {x}_{1}^{( 1 )} . \qquad ( 19 )$$

To create dark traps, the transmittance of the reflecting regions, tₐ, is chosen to be zero. Such a selection may be easier to fabricate reliably compared to using a specific finite value for tₐ. To create the deepest possible trap, the central amplitude of the field in the image plane should be zero:

$$ϵ = - {t}_{b} + {t}_{b} [ 1 - {J}_{0} ( \frac{kab}{f} ) ] = 0 {J}_{0} ( \frac{kab}{f} ) = 0. \qquad ( 20 )$$

The relationship between Fourier-plane aperture radius b and the dark-trap mask aperture radius α_{dark} may be determined:

$$b = \frac{f}{{ka}_{dark}} {x}_{1}^{( 0 )} . \qquad ( 21 )$$

Since both dark traps and bright traps share one single Fourier-plane filter, the value b for both dark and bright traps are the same. Thus, we can get the following relationship between α_{bright} and α_{dark}:

$$\frac{f}{{ka}_{dark}} {x}_{1}^{( 0 )} = \frac{f}{{ka}_{bright}} {x}_{1}^{( 1 )} . \qquad ( 22 )$$

$$And$$

$${a}_{bright} = \frac{{x}_{1}^{( 1 )}}{{x}_{1}^{( 0 )}} \cdot {a}_{dark} = \frac{3.8317}{2.4048} \times {a}_{dark} = 1.593 \times {a}_{dark} . \qquad ( 23 )$$

By way of example, atoms should not be any closer than about 3˜4 μm for Rydberg atom-based quantum computing. Also, traps for single atoms need to have waist of 1 1-2 μm. As a result the period should be around 4 times larger than the size of the apertures. Based on these requirements, trapping profiles for two species for this atom-based quantum-computing application may be determined. We can get the following parameters:

$${a}_{dark} = 75 μ m \qquad ( 24 )$$

$${a}_{bright} = 1.593 \times 75 μ m = 119.475 μ m \approx 120 μ m$$

$$period = 4.3 \times 120 μ m = 516 μ m .$$

To achieve equal trapping depth for the two atomic species, the light intensities at bright traps and dark traps need to satisfy the Equations 25-28, where a is the ground-state polarizability of the atoms. Since different species of atoms are trapped in dark and bright traps, the ground state polarizability will be different. For example, rubidium and cesium atoms at a wavelength of 808 nm have α_{Rb} of 847 Å³ and α_{Cs} of −433 Å³. We note that for this particular structure, the depth of the dark traps is actually slightly deeper than (t_{b})I₀ because of the existence of ripples around the dark traps due to interference, as shown in FIG. 4. The enhancement of the trap depth due to the ripples can be quantified as follows, where the coefficient of enhancement, ε′, is around 1.1 to 1.3:

$${α}_{bright} {I}_{bright} = {α}_{dark} {ε}^{′} {I}_{dark} \qquad ( 25 )$$

$${I}_{bright} = {( - {t}_{b} - ( 1 - {t}_{b} ) [ 1 - {J}_{0} ( {x}_{1}^{( 1 )} ) ] )}^{2} {I}_{0} - {( {t}_{b} )}^{2} {I}_{0} \qquad ( 26 )$$

$${I}_{dark} = {( {t}_{b} )}^{2} {I}_{0} \qquad ( 27 )$$

$$847 \times \{ 2 {t}_{b} ( 1 - {t}_{b} ) ( 1 + 0.40276 ) + {( 1 - {t}_{b} )}^{2} \cdot {[ 1 + 0.40276 ]}^{2} \} = 1.2 \times 433 \times {( {t}_{b} )}^{2} {t}_{b} = 0.83 ( when {ε}^{′} = 1.2 ) , Tb = {t}_{b}^{2} \approx 69 \% \qquad ( 28 )$$

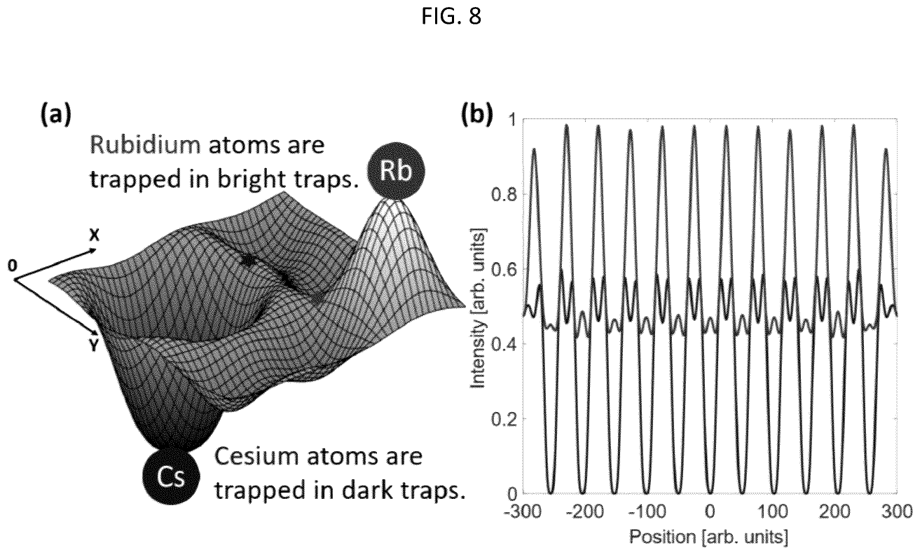

The design considerations for the first mask outlined above may be improved by considering interference between neighboring traps. To simulate the light-intensity distribution in the image plane, a 2D simulation may be performed that considers the interference between the dark and bright traps to verify and then slightly re-design the mask. Using this 2D simulation, FIG. 8a shows the intensity distribution using parameters shown in Equation 24 and 28 with fringes around the traps. In FIG. 8b, the intensity line profiles of both dark and bright traps are plotted together. The line profiles are both plotted along the x-direction of FIG. 8a, also crossing the maximum point for the bright trap and minimum point for the dark trap.

Due to the ripples appearing around the edge of the trap region, the line profiles do not represent the trapping depth accurately. The trapping depth of each trap is determined by the shallowest point which allows the atom to leave the trap. The shallowest points of the bright trap and the dark trap are highlighted using stars for each in FIG. 8a. The 2D simulation provides a more accurate way to determine the trapping depth of two-species traps instead of using the analytical solution of single trap to estimate the trapping depth. The simulation was carried out using a program written in the Python programming language which implemented Fresnel diffraction theory to numerically propagate a scalar field, represented as a complex-valued array, through the optical system described. The 2D simulation uses far-field approximation, and a fast Fourier transform (FFT) may be used to get the electric field profile in the far field. First, a FFT is applied to the electric field profile after the two-species mask to get the field profile after the first lens, which is also the field profile at the Fourier plane. Second, we filter out the electric field outside of the aperture at the Fourier plane. Then, an inverse FFT is applied to get the field profile after the second lens, which is also the field profile at the image plane.

With the aid of 2D simulation of the whole two-species trap array, the transmission mask can account for the interference-based ripples in the intensity in the image plane. Compared to the parameters in Equation 28, the determined transmittance of the background should 73% such that the trap depths for the species are equal.

TABLE 1

| | | | Transmittance of |
|---|---|---|---|
| Radius of bright disk | Radius of dark disk | Period | background |
| 120 μm | 75 μm | 516 μm | 73% |

Next, we present a method to implement the parameters in Table 1, realizing a two-species mask, such that they can be fabricated using semiconductor industry compatible processes and commonly used materials. These semiconductor-industry compatible processes and materials allow this design to be mass-produced using semiconductor foundries at relatively low cost. FIG. 7 shows the final fabricated two-species mask. Discrepancy between the as-fabricated parameters in this figure and Table 1 due to the fabrication method. These differences can be eliminated by slightly altering the fabrication process.

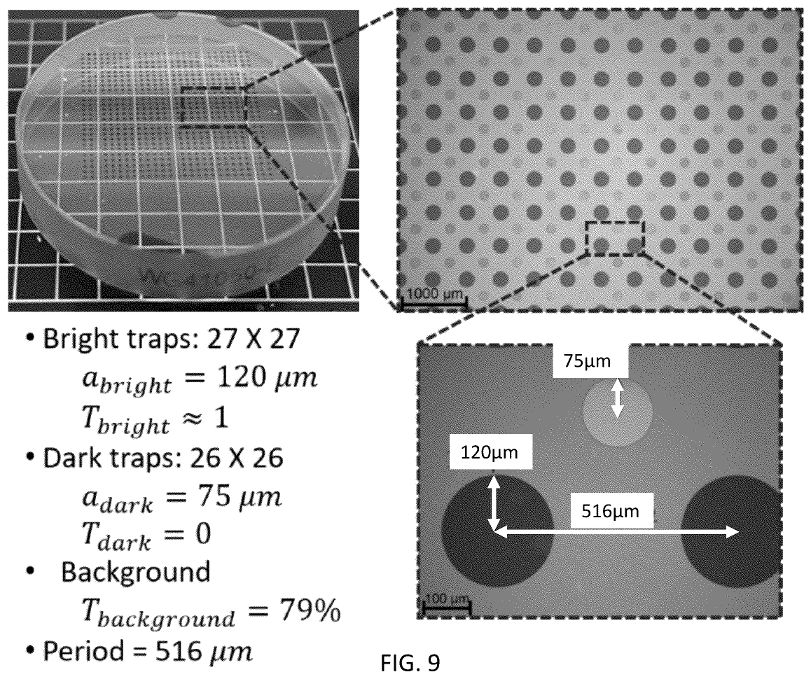

There are three different regions in the design shown in FIG. 9: a transparent region (T_{bright}˜1), which corresponds to exposed transparent substrate at the apertures, an opaque region (T_{dark}=0), which is implemented with an optically thick layer of metal (here, gold), and a background region with a particular desired transmittance (T_{background}=0.73). Additionally, there not be a substantial phase shift (roughly less than 20 degrees) between the background region and the transparent regions.

For the opaque regions, gold was used because it is a stable and metallic material which can reflect all the incident light to reduce the transmittance close to zero. The thickness of gold film is not critical as long as it is thick enough to provide near zero transmittance. A 100 nm gold film was used which gives transmittance lower than 0.10% based on the calculation. Other materials may be used.

To achieve the desired transmittance and small phase shift in background region, a thin layer of material with an intermediate degree of absorption such that a subwavelength-thick layer of this material results in absorption of 20-30% of the incident light without a significant phase shift. Additionally, the absorption is not too high such that it cannot be controlled on the single-% level by changing deposition conditions, such as deposition time. Direct-gap or amorphous semiconductors with band gaps smaller than the photon energy, such as amorphous germanium, gallium arsenide, and indium arsenide, may be used.

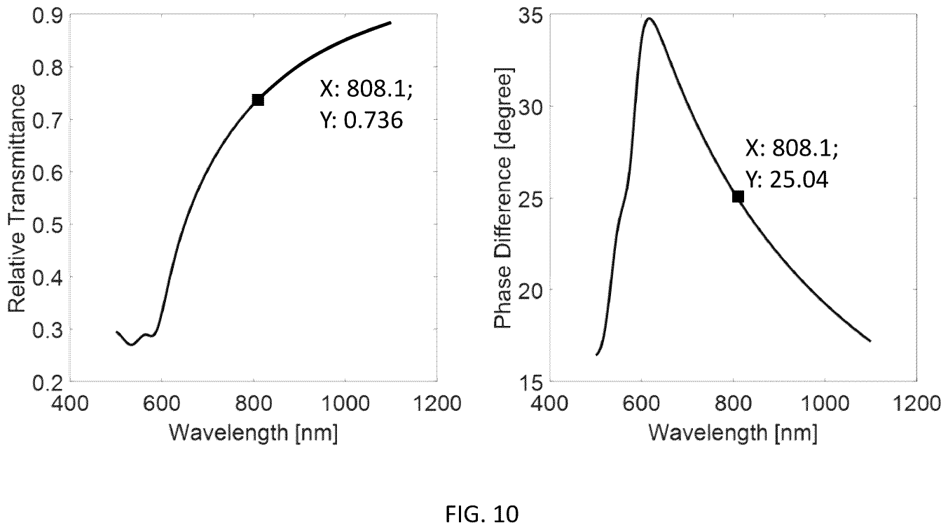

Based on our calculation, a ˜7 nm layer of evaporated amorphous germanium satisfies these criteria. Since 7 nm is much smaller than the light wavelength (around 800 nm in free space, or about 174 nm in the material that we deposited), the phase shift of light passing through the background region is sufficiently small. We used the transfer matrix method (TMM) to calculate the transmittance and phase shift in the background region, and the results are shown in FIG. 10. Note also that 7 nm is thick enough that this thickness can be reasonably controlled in a typical physical vapor deposition (PVD) system.

The mask was prepared using conventional semiconductor manufacturing processes: deposition, lithography and etching. The substrate used is a 1-inch fused silica window with commercial double-sided anti-reflective (AR) coatings. Other transparent materials may be used.

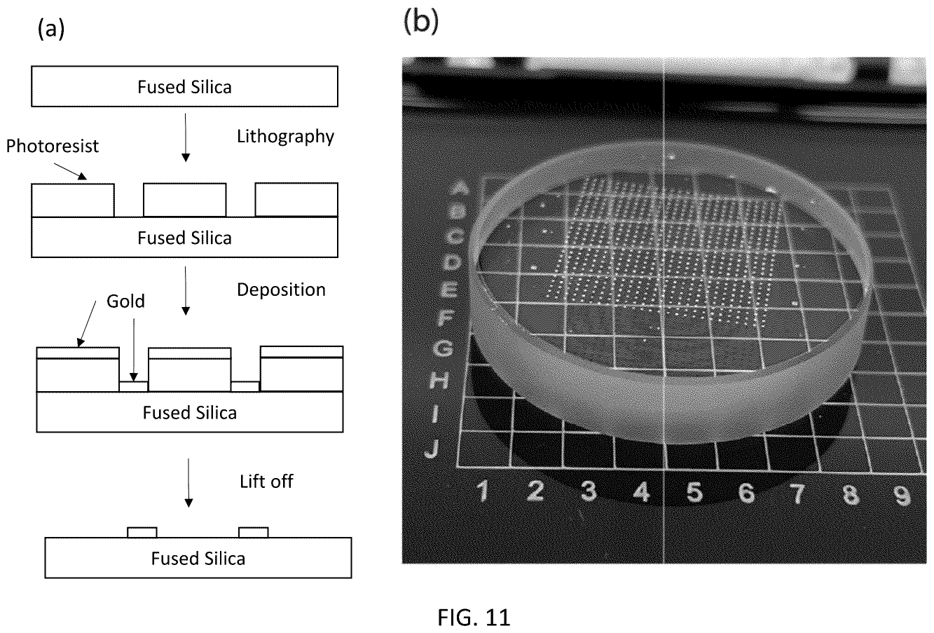

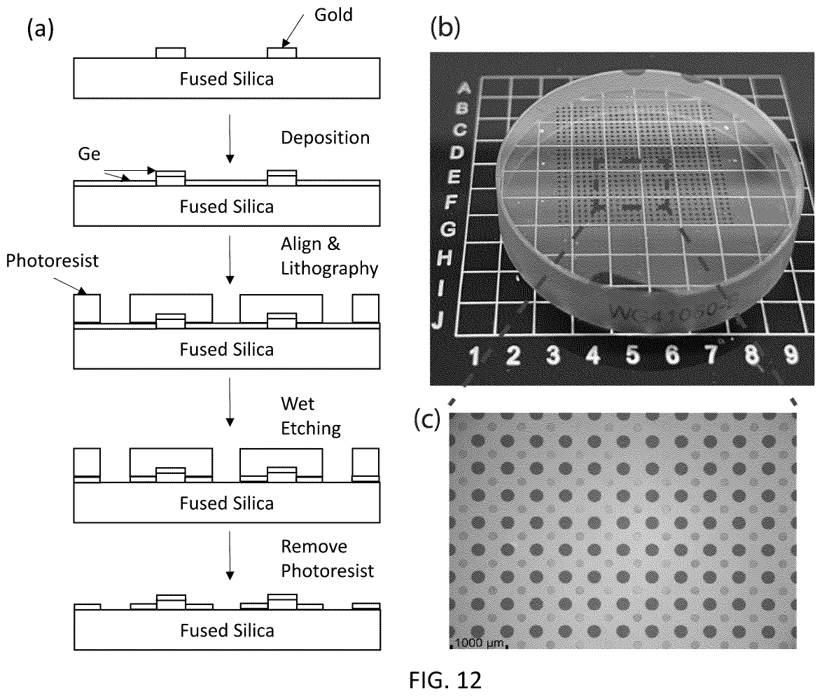

The process can be separated into two broad steps; the first, presented in FIG. 11, results in a mask that can be used for single-species trapping, and then the second step, presented in FIG. 12, builds on this structure, resulting in a two-species trap. Suitably, the method comprises preparing a multiplicity of reflecting regions that are substantially opaque at a frequency of the projected light on a substrate that is substantially transparent at the frequency of projected light; and preparing a subwavelength thick layer of a background material having a multiplicity of apertures in the background material on the substrate, where the subwavelength thick layer of a background material has a background transparency between the substrate and the multiplicity of reflecting regions at the frequency of the projected light on the substrate and where the background transparency is selected to form regions of light intensity maxima configured to trap a first species of particle and regions of light intensity minima configured to trap a second species of particle when the light is projected on the mask.

An exemplary method for preparing the reflecting regions is illustrated in FIG. 11. First, gold disks discs were fabricated for dark trapping using a lift-off photolithography process. Laser-lithography (LL) was used to transfer the small disk patterns into S1813 photoresist. After development, 2 nm thin titanium film was deposited by e-beam evaporation to increase the adhesion between gold and fused silica. Then, a 100 nm gold film was evaporated. After deposition, this sample was put into hot resist remover to lift off the gold. FIG. 11a is the fabrication flow chart of a single-species array generator using the lift-off process. FIG. 11b is the image of fabricated single-species array generator.

An exemplary method for preparing the subwavelength thick layer having apertures is illustrated in FIG. 12. An amorphous germanium thin film was deposited, using directional evaporation, resulting in the background region. Note that the germanium is also deposited on top of the gold, regions, but this does not change the transmittance which is already ˜0. Then another layer of photoresist was spun, and laser lithography with alignment was used to expose the regions that will become the bright traps. The pattern of bright traps is aligned to be in between dark traps with spacing determined by the needs of an atomic experiment or device. After exposure and development, the germanium is etched away using a hydrogen peroxide wet etching process. Photoresist residues are removed using remover 1165. FIG. 12a shows the fabrication flow chart of dual-species array generator starting with fabricated single-species array generator from FIG. 11a. FIG. 12b is the image of fabricated device and FIG. 12c is a microscope image of the fabricated disks.

Alternative methods for preparing the mask may also be implemented by those of skill in the art. For example, the subwavelength thick layer having apertures may be prepared by deposition and liftoff of the background material to prepare a similar article.

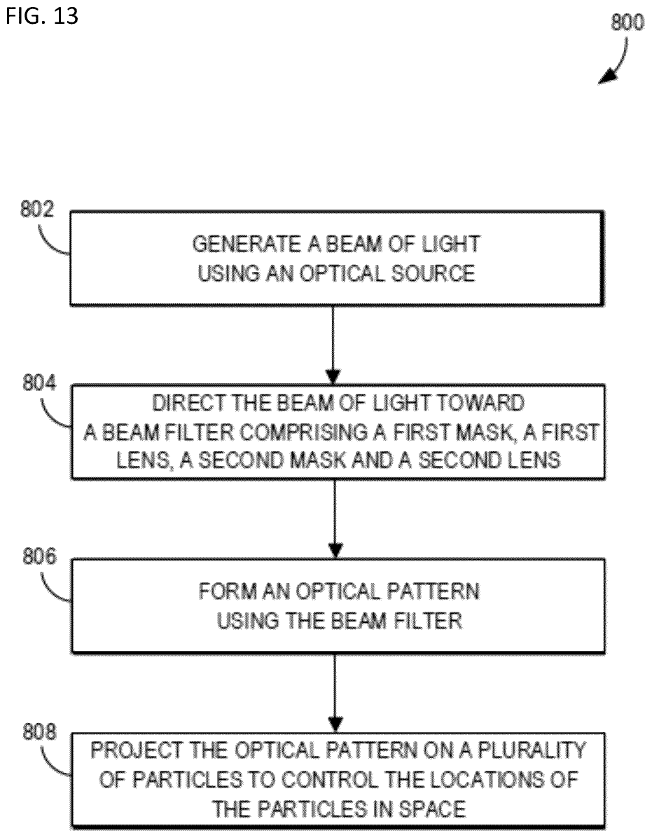

Turning now to FIG. 13, steps of a process 800 for controlling particles using projected light, in accordance with the present disclosure, are provided. In some implementations, steps of the process 800 may be carried out using systems described herein, as well as other suitable systems or devices.

The process 800 may begin at process block 802 with generating a beam of light using an optical source. As described, the light beam generated by the optical source may have a variety of properties, including various frequencies, wavelengths, power levels, spatial profiles, temporal modulations, and so on. In some aspects, the light beam may have frequencies shifted from resonances of different species of particles to be trapped.

The beam of light may then be directed to a beam filter, as indicated by process block 804. In accordance with aspects of the present disclosure, the beam filter may include a first mask, a first lens, a second mask and a second lens. In some variations, the beam filter may further include a third mask positioned between the first mask and the first lens, where the third mask may include a phase scrambling mask. The beam filter may be configured such that the beam of light passes sequentially through the first mask, optionally the third mask, the first lens, the second mask, and second lens, and thereafter exists the beam filter to form an optical pattern, as indicated by process block 806. As described, the optical pattern may have a variety of configurations depending on the particular application.

The optical pattern may then be projected on a plurality of first species of particles and a plurality of second species of particles (e.g. different atomic particles) to control their locations in space, as indicated by process block 808. To this end, the particles may be provided by a particle system that is configured to generate and confine them to a particular volume or a general location in space. As described, the provided particles can be held in a vacuum and cooled to temperatures suitable for optical trapping.

The present invention has been described in terms of one or more preferred embodiments, and it should be appreciated that many equivalents, alternatives, variations, and modifications, aside from those expressly stated, are possible and within the scope of the invention.

1. A mask for controlling multiple species of particles using projected light, the mask comprising:
a substrate that is substantially transparent at a frequency of the projected light;
a multiplicity of reflecting regions formed from a reflective material deposited on the substrate that are substantially opaque at the frequency of the projected light, and
a subwavelength-thick layer of background material disposed on the substrate and having a multiplicity of apertures therein,
wherein the subwavelength-thick layer of background material has a background transparency between the substrate and the reflective material at the frequency of the projected light and
wherein the background transparency is selected to form regions of light intensity maxima configured to trap a first species of particle and regions of light intensity minima configured to trap a second species of particle when the light is projected on the mask.

2. The mask of claim 1, wherein the background material is selected from a direct-gap semiconductor and/or amorphous semiconductor having a band gap less than the photon energy of the frequency of the projected light.

3. The mask of claim 1, wherein the background material is selected from amorphous germanium, gallium arsenide, amorphous silicon, polycrystalline silicon, indium tin oxide, fluorine-doped tin oxide, and indium gallium arsenide.

4. The mask of claim 1, the background material is selected to result in an optical phase shift less than 30° between light transmitted through the substrate alone and through the background material.

5. The mask of claim 1, wherein the apertures and the reflecting regions are circular and the ratio of the radius of the apertures to the radius of the reflecting regions is between 1.0 and 2.0.

6. The mask of claim 1, wherein the apertures are circular and the multiplicity of apertures have a periodicity of at least 4 times larger than the radius of the apertures.

7. The mask of claim 1, wherein the background transparency is selected to have substantially equal trapping depths in the regions of light intensity maxima for the first species of particle and regions of light intensity minima for the second species of particle.

8. The mask of claim 1, wherein the background transparency is between 0.30 and 0.85 percent.

9. The mask of claim 1, wherein the background transparency is between 0.65 and 0.75 percent.

10. The mask of claim 1, wherein the background material has a thickness less than 20 nm.

11. The mask of claim 1, wherein the background material has a thickness between 5 nm and 10 nm.

12. The mask of claim 1, wherein the first species of particle is a first species of neutral atom and the second species of particle is a second species of neutral atom.

13. The mask of claim 1, wherein the first species of particle is a Rb atom and the second species of particle is a Cs atom.

14. A system for controlling multiple species of particles using projected light, the system comprising:
a particle system configured to provide a plurality of a first species of particles and a plurality of a second species of particles;
an optical source configured to generate a beam of light with a red-shift from a resonance of the first species of particles and a blue-shift from a resonance of the second species of particles; and
a beam filter positioned between the particle system and plurality of particles, and comprising a first mask, a first lens, a second mask, and a second lens,
wherein the first mask is the mask according to claim 1 and
wherein the optical source, beam filter, and particle system are arranged such that the beam of light from the optical source passes through the beam filter and is projected on the plurality of first species of particles and the plurality of second species of particles to form an optical pattern that controls the positions of the plurality of first species of particles and plurality of second species of particles in space.

15. The system of claim 14, wherein the first mask is positioned a first focal length away from the first lens, and the second mask is positioned a first focal length away from the first lens and a second focal length away from the second lens.

16. The system of claim 14, wherein the first species of particle is a first neutral atom and the second species of particle is a second neutral atom.

17. A method for controlling multiple species of particles using projected light, the method comprising:
generating a beam of light using an optical source;
directing the beam of light to a beam filter comprising a first mask, a first lens, a second mask, and a second lens;
forming an optical pattern using the beam filter; and
projecting the optical pattern on a plurality of first species of particles and a plurality of second species of particles to control their locations in space,
wherein the first mask is the mask according to claim 1.

18. A method for preparing a mask for controlling multiple species of particles using projected light, the method comprising:
preparing a multiplicity of reflecting regions that are substantially opaque at a frequency of the projected light on a substrate that is substantially transparent at the frequency of projected light; and
preparing a subwavelength thick layer of a background material having a multiplicity of apertures in the background material on the substrate,
wherein the subwavelength thick layer of a background material has a background transparency between the substrate and the multiplicity of reflecting regions at the frequency of the projected light on the substrate and
wherein the background transparency is selected to form regions of light intensity maxima configured to trap a first species of particle and regions of light intensity minima configured to trap a second species of particle when the light is projected on the mask.

19. The method of claim 18, wherein the method comprises:
removing a first photoresist deposited on the substrate that is substantially transparent at a frequency of projected light, wherein removing the first photoresist results in a multiplicity of substrate-exposed regions;
depositing the reflecting material onto the multiplicity of substrate-exposed regions, wherein the deposited reflecting material is substantially opaque at the frequency of projected light;
removing the first photoresist, wherein removing the photoresist results in the multiplicity of reflecting regions that are substantially opaque at the frequency of projected light and exposed substrate;
depositing the subwavelength thick layer of the background material onto the exposed substrate, wherein the deposited background material has the background transparency between the substrate and the multiplicity of reflecting regions at the frequency of the projected light;
depositing a second photoresist onto the background material;
exposing regions of the background material by selectively removing the second photoresist;
etching the exposed regions of the background material, wherein etching the exposed regions of the background material results in the multiplicity of apertures in the background material and a remaining portion of the second photoresist; and
removing the remaining portion of the second photoresist.

20. The method of claim 18, wherein the background material is selected to have phase shiftless than 30° between the substrate and the background material and/or the background material to have a band gap less than the photon energy of the frequency of the projected light.
